(19) United States
(12) Patent Application Publication
(10) Pub. No.: US 2014/0115340 A1
(43) Pub. Date: Apr. 24, 2014

(54) UNIQUE DEVICE IDENTIFIER PROVISION METHOD AND APPARATUS

(71) Applicant: Samsung Electronics Co., Ltd., Gyeonggi-do (KR)

(72) Inventor: Jihyun LEE, Gyeonggi-do (KR)

(73) Assignee: Samsung Electronics Co., Ltd., Gyeonggi-do (KR)

(21) Appl. No.: 14/054,926

(22) Filed: Oct. 16, 2013

(30) Foreign Application Priority Data
Oct. 19, 2012 (KR) 10-2012-0116577

(51) Int. Cl. H04L 29/06

(52) U.S. Cl. CPC H04L 63/08
USPC 713/182

(57) ABSTRACT

A method and apparatus for providing a user device with a unique identifier for reinforcing the security of communication with a server includes displaying a CAPTCHA image including a security key received from a server in response to a connection attempt to the server; receiving a security key input by the user, the security key being included in the CAPTCHA image; computing a hash value using the security key input by a user; transmitting the hash value to the server; and registering, when a connection response is received from the server in response to the hash value, the security key based on hash value as a unique identifier necessary for connection with the server.

### CLAIM OF PRIORITY

This application claims the benefit under 35 U.S.C. §119(a) from a Korean patent application filed on Oct. 19, 2012 in the Korean Intellectual Property Office and assigned Serial No. 10-2012-0116577, the entire disclosure of which is hereby incorporated by reference.

### BACKGROUND

1. Field of the Invention

The present disclosure relates to a connection between a user device and a server and, in particular, to a method and apparatus for providing the user device with a unique identifier to reinforce the security of communication therebetween.

2. Description of the Related Art

With the popularity of mobile devices, protection of personal information and asset is becoming a major issue. Currently, the conventional device authentication method involves generating a unique value with the hardware information of a user device which can be verified for accessing information. For example, the unique value is can be any of the unique hardware information assigned to the device at the manufacturing state (e.g. Internal Mobile Equipment Identity (IMEI), manufacturing sequence, manufacturing serial, and Internal mobile Subscriber Identity (IMSI) stored in the Subscriber Identity Module (SIM) card. In operation, the user device ciphers the unique device information into a key for device authentication and sends the retrieve key information to the server.

Since the personal information or unique device information may pose a security issue during transmission, it is preferred to prevent such information from being transmitted through public networks as much as possible. However, in practice, using the unique device information as a means for authentication between the server and the user device is readily in use.

Meanwhile, in the case of using the personal information as authentication information, it is typical to transmit the information with ciphering or hash value. However, the cipher-based method has a drawback in that the key management process is very complex in many cases. Also, the hash-based method has a problem in that since the hash result is a random binary value the server cannot verify whether the value is generated correctly or by an illegal computer program such as virus.

Further, these conventional methods cause undesirable overhead in managing the cipher keys and the value verification is very difficult which in turn cause the server to be vulnerable to overload attack.

### SUMMARY

The present invention has been made in an effort to solve the above problem and provides additional advantages, by providing a unique device identifier provision method and apparatus that is capable of protecting against the overload attack to the server by distinguishing between access requests of the valid user and illegal computer program.

It is another aspect of the present invention to provide a unique device identifier provision method and apparatus capable of using the device information of the terminal which is provided by the server as the authentication information necessary for the terminal's access to the server.

It is another aspect of the present invention to provide a unique device identifier provision method and apparatus capable of protecting against illegal access by negating collection of the device information or user information for use during connection between the user device and server.

It is still another aspect of the present invention to provide a unique device identifier provision method and apparatus capable of generating statistic data using the log data such as number of downloads and connections based on the unique identifier assigned from the server to the user device.

In accordance with an aspect of the present invention, a unique identifier provision method of a user device includes displaying a CAPTCHA image received from a server in response to a connection request to the server; receiving a security key input by the user, the security key being included in the CAPTCHA image; computing a hash value using the security key input by the user; transmitting the hash value to the server; and storing, when a connection response is received from the server in response to the hash value, the security key based on the hash value as a unique identifier used for connection with the server.

In accordance with another aspect of the present invention, a unique identifier provision method of a server includes receiving a connection request from a user device; transmitting to the user device a CAPTCHA image including a private key serving as a unique identifier of the user device; determining, when a hash value generated with the private key included in the CAPTCHA image is received from the user device, whether a security key of the received hash value matches the private key; registering, when there is a match, the security key as the unique identifier of the user device; and transmitting a connection response to the user device for establishing a connection.

In accordance with another aspect of the present invention, a computer-readable storage medium stores a program of executing the above methods at a processor.

In accordance with an aspect of the present invention, a user device includes a display which displays a CAPTCHA image including a security key from a server; a user interface which receives the security key included in the CAPTCHA image; and a controller controlling the display unit for displaying the CAPTCHA image received from the server in response to an initial connection attempt, transmitting a hash value computed using the security key, ciphering the security key with information of the user device, storing the ciphered security key in a storage as a unique identifier of the server, and transmitting, when establishing a connection with the server, a different hash value generated using the stored unique identifier and according to a random Round_Count received from the server.

In accordance with still another aspect of the present invention, a unique identifier provision system of a user device includes a server which transmits a CAPTCHA image having a security key serving as unique identifier of a user and registers, when a hash value computed using the security key from the user device, the security key based on the hash value as the unique identifier of the user device; and the user device which displays the CAPTCHA image received from the server, transmits, when the security key included in the CAPTCHA image is inputted, the hash value computed using the security key from the server, and registers, when a connection response is received from the server in response to the hash value, the security key based on the hash value as the unique identifier for connection with the server.

### BRIEF DESCRIPTION OF THE DRAWINGS

FIG. 1 is a schematic diagram illustrating the architecture of a communication system to which the present invention is applied;

FIG. 2 is a block diagram illustrating a configuration of the user device according to an embodiment of the present invention;

FIG. 3 is a signaling diagram illustrating the procedure of issuing a unique identifier for communication between a user device and a server according to an embodiment of the present invention;

FIG. 4 is a signaling diagram illustrating the procedure of establishing a connection between a user device and a server after the issuance of a unique identifier according to an embodiment of the present invention;

FIG. 5 is a flowchart illustrating the procedure for the server to issue a unique identifier to the user device according to an embodiment of the present invention;

FIG. 6 is a flowchart illustrating the procedure for the user device to acquire unique identifier for use in connection with the server according to an embodiment of the present invention;

FIG. 7 is a flowchart illustrating the procedure for the server to authenticate the user device according to an embodiment of the present invention; and

FIG. 8 is a flowchart illustrating the procedure for the user device to establish a connection to the server using a unique identifier according to an embodiment of the present invention.

### DETAILED DESCRIPTION

Exemplary embodiments of the present invention are described with reference to the accompanying drawings in detail. The same reference numbers are used throughout the drawings to refer to the same or like parts. For the purposes of clarity and simplicity, detailed description of well-known functions and structures incorporated herein may be omitted to avoid obscuring the subject matter of the present invention. That is, the description is made only with the operations necessary in the embodiments of the present invention, and other parts that may cause obscurity of the subject matter of the present invention are omitted.

The present invention proposes a method for reinforcing security of the connection between a user device and a server using the unique identifier generated and assigned by the server without using the device information of the user device. The device information may include at least one of International Mobile Equipment Identity (IMEI), manufacturing serial, and International Mobile Subscriber Identity (IMSI) stored in a Subscriber Identity Module (SIM) card). The method according to an embodiment of the present invention is capable of protecting against the attack of the server by identifying illegal identifier using the server's authentication mechanism and rejecting connection, download, and webpage request generated by an illegal computer program such as virus so as to protect against the overload attack, e.g. Distributed Denial of Service (DDoS) attack of the server.

In the following description, a Completely Automated Public Test to tell Computers and Humans Apart (CAPTCHA) image denotes that the image is transmitted by the server to be displayed on the user device to check whether the current access attempt to the server is from the valid user or a computer program. Particularly in an embodiment of the present invention, the CAPTCH image includes the unique identifier (or security key or Server_Nonce) as authentication information for authenticating the user device at the server. The unique identifier is a random string included in the CAPTCHA image transmitted from the server to the user device and used as the authentication information for authenticating the user device. Such a unique identifier is inserted into the CAPTCHA image by the server. That is, The CAPTCHA image is the image presented in a complex pattern acquired by visually modifying characters of the unique identifier generated by the server randomly so as not to be identified by the user but the computer program.

In the following, the unique device identifier provision apparatus and method according to embodiments are described with reference to accompanying drawings. However, the present invention is not limited to the following embodiments but may be implemented in various types.

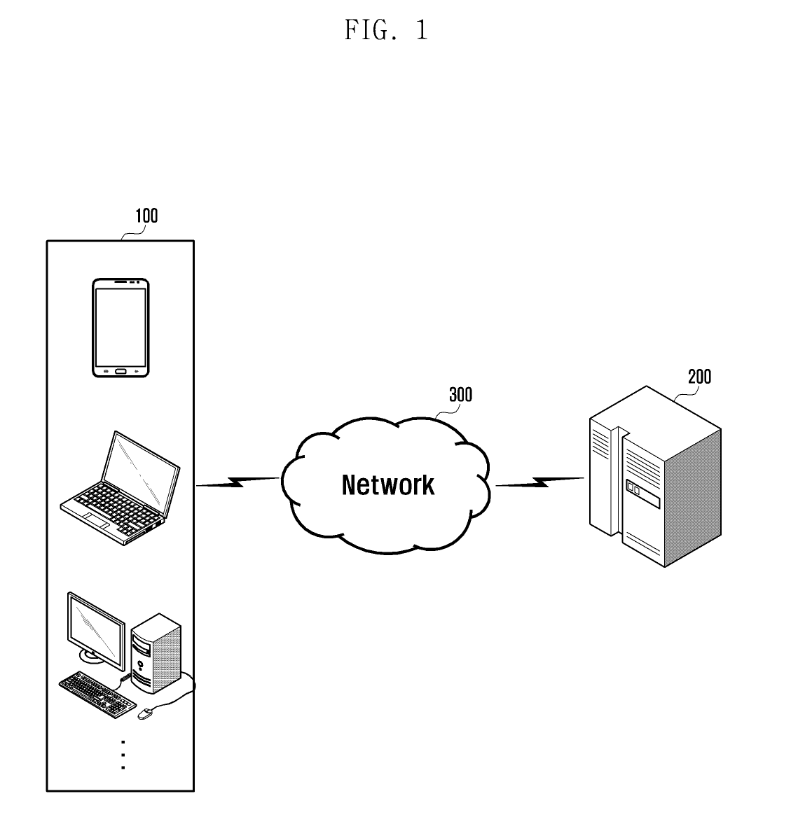

FIG. 1 is a schematic diagram illustrating the architecture of a communication system to which the teachings of the present invention is applied to.

As shown, the communication system includes user devices 100 in communication with a server 200 via a network 300. In the embodiment, the user devices 100 may include all the types of information communication devices, multimedia devices, and their equivalents equipped with at least one of Application Processor, Graphic Processing Unit (GPU), and Central Processing Unit (CPU). For example, the user devices 100 are capable of including mobile terminals operating with various communication protocols, tablet Personal Computer (PC), smartphone, digital camera, Portable Multimedia Player (PMP), media player, game console, Personal Digital Assistant (PDA), laptop computer, desktop computer, duplex system, etc. Also, the method of the present invention can be applied to various display devices including Digital Television (TV), Digital Signage (DS), Large Format Display (FLD), etc.

In the system including the user devices 100 and the server 100 as shown in FIG. 1, when a request for authentication is received from the user device 100, it is difficult for the server 200 to verify the validity of the authentication request, i.e. it is difficult to determine whether the request is issued by a valid user or a virus (illegal computer program). In the conventional method, the user authentication is performed between the server 200 and the user device 100 using the device information of the user device 100. In the case of using the device information, however, the security is not guaranteed since the device information and the user information are transmitted via a security network 300, which may be vulnerable to a virus attack or can be compromised. In order to supplement and enhance the security, many methods for reinforcing the security using ciphering and hashing value have been proposed.

However, a unique identifier provision method based on ciphering the device information has a drawback in that the key management is very complex. Also, the hash-based method has a problem in that since the hash result is a random binary value, the server cannot verify whether the binary value is generated correctly or by an illegal computer program such as virus.

To overcome the above short-comings, according to an embodiment of the present invention, the server 200 generates a unique identifier corresponding to the user device 100 directly. With this identifier, the server 200 is capable of distinguishing the request issued by a user from an illegal computer program such as virus, thereby warding off the overload attack to the server 200 from outside.

Referring to FIG. 1, the unique identifier provision method of the present invention can be divided into a procedure of issuing, at the server 200, a unique identifier to device 100 and a procedure of communication between the server 200 and the device 100 with the issued identifier.

First, a description is made of the procedure of issuing an initial unique identifier to the user device 100.

If an Access Request is received from the user device 100, the server 200 issues a first security key to be used as a unique identifier of the user device. The first security key is a random string inserted into a CAPTCHA image transmitted form the server 200 to the user device 200 so as to be used as a unique identifier of the user device 100 at the final stage which is referred to as Server_Nonce in the embodiment. That is, the server 200 inserts the first security key (Server_Nonce) into the CAPTCHA image and transmits the CAPTCHA image with the private key (or security key) of the server 200 as a signature to the user device 100. Note that the first security key (Server_Nonce) can be used as the signature.

If the CAPTCHA image is received from the server 200, the user device 100 verifies the server 200 with a public key of a trusted server.

According to an embodiment of the present invention, the public key of the trusted server can be issued to the user device 100 in advance to ward off any attack from an untrusted server. The trusted server can be a security server or an authentication authority with the trusted security function at least for securing the communication between the user device 100 and the server 200. The public key is the key value provided by a designated trusted server or authentication authority, and thus the user device is capable of verifying the trusted server using the public key.

If it is verified that the server 200 is the trusted server, the user device 100 displays the received CAPTCHA image on the screen. In this state, the user device 100 waits for receiving a user input in a predetermined duration. If no user input is received in the predetermined duration, the user device 100 terminates the security configuration procedure with the CAPTCHA image. The user is capable of checking the first security key (Server_Nonce) included in the CAPTCHA image displayed on the screen of the user device 100 and inputting a second security key (Server_Nonce) using an input means of the user device 100.

If the second security key (Server_Nonce) is input by the user, the user device 100 computes a hash value with Hash Function and sends the hash value to the server 200. That is, the user device 100 converts the second security key (Server_Nonce) input by the user through hashing and sends the hash value (hashed security key Server_Nonce) to the server. The reason for avoiding transmission of the security key (Server_Nonce) as it was input directly without the conversion, is to prevent an illegal computer program (virus) such as ‘packet monitor’ from faking the security key. That is, since the network 300 bridging between user device 100 and the server 200 is vulnerable in security aspect, it is preferred to transmit the second security key hashed by a hash algorithm to the server 200 which further reinforces the security.

If the hash value transmitted by the user device 100 as a response to the CAPTCHA image is received, the server 200 performs hashing on the second security key (Server_Nonce) it has generated to compute the hash value, and compares the hash values computed and received from the user devices 100. If the hash values match, the server 200 registers the security key (Server_Nonce) as the unique identifier of the user device 100. Here, the server 200 may generate and manage the hash value in advance at the time when generating the security key (Server_Nonce).

After registering the unique identifier of the user device 100, the server 200 accepts the access request of the user device 100 and notifies the user device of the registration of the unique identifier with the security key (Server_Nonce).

Upon receipt of the message accepting the access request and notifying of the identifier registration, the user device 100 ciphers and store the security key (Server_Nonce) for use as the unique identifier of the user device 100 in communication with the server 200.

Now, a description is made of the operation of the user device after the issuance of the unique identifier through the above-described operation.

As described above, the user device 100 is capable of storing the unique identifier issued during the process of unique identification distribution procedure in the state when connected with the server 200. The user device 100 is capable of attempting access to the server 200 using the stored unique identifier. At this time, the user device 100 and the server 200 reinforce the security by changing the hash value (data or packet) by increasing Hash Round at every connection instance to ward off the replay attack to the server 200. The replay attack is a network attack in which a valid data (e.g. unique identifier) is copied and retransmitted maliciously or fraudulently.

That is, the user device 100 increases the hash round at every connection attempt to the server 200 so as to transmit different data (packet) to the server 200 each time. Also, the server 200 increases the hash round to verify the user device 100 in the synchronized state. At this time, the server 200 is capable of generating and managing statistical data of the user device 100 using the information on the connection attempt in association with the hash round. That is, the server is capable of checking the log data such as numbers of download and connection attempts of the user device 100 with the unique identifier assigned to the user device 100 and generating the statistical data with the log data for use in communication management.

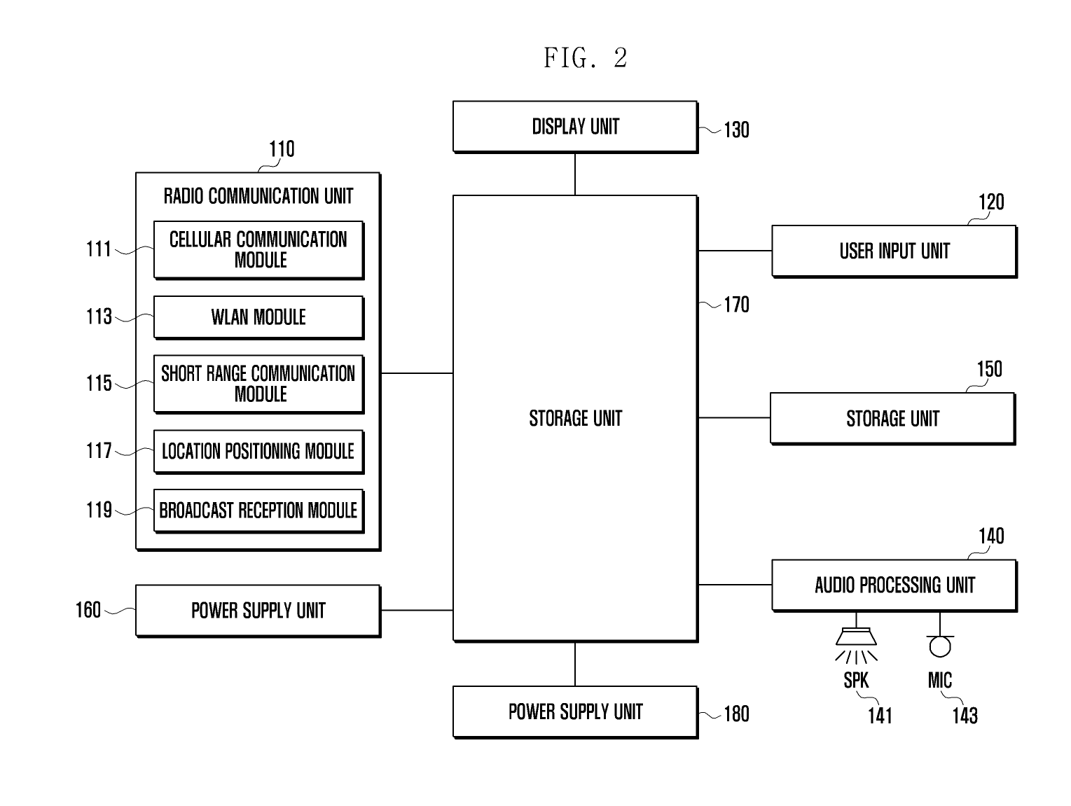

FIG. 2 is a block diagram illustrating a configuration of the user device 100 according to an embodiment of the present invention.

As shown, the user device 100 may include a radio communication unit 110, a user input unit 120, a display unit 130, an audio processing unit 140, and a storage unit 150, an interface unit 160, a control unit 170, and a power supply unit 180. It should be noted that the user device 100 of the present invention is not limited to the configuration of FIG. 2 but can be implemented without any of the aforementioned components and/or with further more components not enumerated herein.

The radio communication unit 110 may include one or more modules capable of radio communications with the server 200, radio communication system (e.g. broadcast server, base station, satellite, etc.) and other user device. For example, the radio communication unit 110 may further include a cellular communication module 111, a Wireless Local Area Network (WLAN) module 113, a short range communication module 115, a location positioning module 117, a broadcast reception module 119, etc.

The cellular communication module 111 communicates radio signals with a base station or a server on a mobile communication network. The radio signals may include voice telephony signal, video telephony signal, text/multimedia message signal, etc. The cellular communication module 111 exchange radio signals carrying data (packet) in the initial connection for unique identifier issuance with the server 200 under the control of the control unit 170. The cellular communication module 111 also exchanges the radio signals carrying the data (packet) of the unique identifier which is modified at every hash round when connecting with the server 200 under the control of the control unit 170.

The WLAN module 113 is the module for establishing a wireless Internet connection or a wireless communication link for communication with another user device. The WLAN module 113 can be implemented as an embedded module or a detachable module. As a wireless Internet connection technology, one of Wi-Fi, Wireless Broadband (WiBro), and World Interoperability for Microwave Access (WiMAX) can be used. When establishing an initial connection with the server 200, the WLAN module 113 exchanges the radio signal carrying data (packet) associated with unique identifier distribution with the server 200. When the connection between the user device 100 and the server 200 is reestablished, the cellular communication module 111 exchanges the radio signals carrying data (packet) with the unique identifier modified at every hash round under the control of the control unit 170. When it has connected to the server 200, the user device 100 is capable of receiving various contents from the server 200 by means of the WLAN module 113 according to the user's preference.

The short range communication module 115 is the module for forming short range radio communication. As the short range communication technology, one of the Bluetooth, Radio Frequency Identification (RFID), Infrared Data Association (IrDA), Ultra Wideband (UWB), ZigBee, and Near Field Communication (NFC) can be used. When the short range communication connection has been established with another device, the short range communication module 115 is capable of transmitting and receiving files selected by the user to and from the other device.

The location positioning module 117 is the module of acquiring location of the user device 100 such as Global Positioning System (GPS) module. The location positioning module 117 acquires the distance information and accurate time information from at least three base stations and computes the current 3-dimensional location with latitude, longitude, and altitude through the triangulation based on the distance and time information. The location positioning module 117 is also capable of acquiring the location information based on the information received from at least three satellites in real time. The location information of the user device also can be acquired in other various ways.

The broadcast reception module 119 receives the broadcast signal (e.g. TV broadcast signal, radio broadcast signal, data broadcast signal, etc.) and/or broadcast information (e.g. broadcast channel information, broadcast program information, broadcast service provider information, etc.) from a broadcast management server through a broadcast channel (e.g. satellite broadcast channel, terrestrial broadcast channel, etc.).

The user input unit 120 generates an input signal in response to the user manipulation for controlling the user device. The user input unit 120 is capable of including at least one of a keypad, a dome switch, a touch pad (capacitive/resistive), jog wheel, and jog switch. The user input unit 120 may include buttons implemented on the outer surface of the user device and/or the touch pad. The user input unit 120 is capable of receiving the second security key (Server_Nonce) input by the user.

The display unit 130 displays (outputs) the information processed by the user device 100. In the voice telephony mode, the display unit 130 displays a User Interface (UI) or Graphic UI (GUI) on the screen. In the video telephony mode or photo shooting mode, the display unit 130 displays the pictures taken by a camera and/or received from the peer device along with the UI/GUI. Particularly in an embodiment of the present invention, the display unit 130 is capable of displaying the UI/GUI associated with the initial connection of the user device to the server 200 and the CAPTCHA image including the security key (Server_Nonce) which has been transmitted by the server 200.

The display unit 130 is capable of being implemented with one of Liquid Crystal Display (LCD), Thin Film Transistor LCD (TFT LCD), Light Emitting Diode (LED), Organic LED (OLED), Active Matrix OLED (AMOLED), flexible display, bended display, and 3-Dimensional (3D) display. This display unit 130 can be implemented with a transparent or semi-transparent display panel.

In the case that the display unit 130 is implemented over a touch panel capable of sensing touch gestures (hereinafter, referred to as ‘touchscreen’), the display unit 130 can work as an input device as well as output device. The touch panel can be implemented to converts the pressure or the change of capacity at a certain part of the display unit 130 into an electrical input signal. The touch panel can be implemented to detect the contact position, contact size, and pressure of the touch gesture. If a touch gesture is detected, the touch panel generates the corresponding input signal(s) to a touch controller (not shown). The touch controller processes the input signal(s) to generate the corresponding data to the control unit 170. Accordingly, the control unit 170 can recognize the touch gesture made on the display unit 130.

The audio processing unit 140 transfers the audio signal output by the control unit 170 to the speaker (SPK) 141 and transfers the audio signal including voice input through the microphone (MIC) 143 to the control unit 170. The audio processing unit 140 converts the voice/sound data to output through the speaker 141 in the form of audible sound wave and processes the audio signal including voice input through the microphone 143 to generate a digital signal to the control unit 170.

The speaker 141 is capable of outputting audio data received by means of the radio communication unit 110 during the telephony mode, recording mode, voice recognition mode, broadcast reception mode, and picture shooting mode, and the receive data can be stored in the storage unit 150. The speaker 141 is capable of outputting the sound signal associated with the functions of the user device 100 (e.g. inbound call reception, outbound call transmission, picture shooting, music file playback, etc.).

The microphone 143 processes the sound signal input during the telephony mode, recording mode, voice recognition mode, and picture shooting mode to output audio data. In the telephony mode, the processed voice data is converted in the format capable of being transmitted to the base station by means of the cellular communication module 111. The sound signal input through the microphone is filtered to remove the noise with various noise cancellation algorithms.

The storage unit 150 stores the programs associated with processing and control of the control unit 170 and input/output data (e.g. security key (Server_Nonce), unique identifier, terminal information, image files, objects, phone numbers, messages, audio, video, e-books, etc.) temporarily or semi-persistently. The storage unit is also capable of storing the information such as usage frequency (e.g. image file usage frequency, application usage frequency, phone number usage frequency, message usage frequency, multimedia usage frequency, etc.), importance, and priority. The storage unit 150 is also capable of storing data related to various patterns of vibration and sound effect to be output upon detecting a touch input on the touchscreen. Particularly in an embodiment of the present invention, the storage unit 150 stores the unique identifier based on the security key (Server_Nonce) issued by the server 200. At this time, the unique identifier can be ciphered and then stored in the storage unit 150 under the control of the control unit 170.

The storage unit 150 may include at least one of flash memory, hard disk, multimedia card micro type memory, card memory (e.g. SD, XD, etc.), Random Access Memory (RAM), Read-Only Memory (ROM), Electrically Erasable Programmable Read-Only Memory (EEPROM), Programmable ROM (PROM), magnetic memory, magnetic disk, and optical disc. The user device is also capable of operating in association with web storage responsible for the storage function of the storage unit 150 on the Internet.

The interface unit 160 provides the user device 100 with a connection interface with external devices. The interface unit 160 is capable of delivering data to an external device and supplying external power to the internal components of the user device 100 and delivering the internal data of the user device 100 to the external device. For example, the interface unit 160 is capable of including wired/wireless headset port, external charging port, wired/wireless data connection port, memory card slot, Subscriber Identity Module (SIM) card slot, audio In/Out (I/O) port, video In/Out port, earphone port, etc.

The control unit 170 controls overall operations of the user device 100. For example, the control unit 170 is capable of controlling the operation related to the voice telephony, data communication, and video telephony. Particularly in an embodiment of the present invention, when the user device 100 and the server 200 establish an initial connection, the control unit 170 controls the operation of acquiring the unique identifier issued by the server 200. For example, the control unit 170 controls receiving the CAPTCHA image transmitted by the server 200 in the initial connection with the server and displaying the received CAPTCHA image on the screen of the display unit 130. Also, when the user enters the security key, the control unit 170 computes the hash value using the security key and sends the hash value to the server 200.

The control unit 170 also controls, when the unique identifier is acquired from the server 200, ciphering of the unique identifier with the device information of the user device and storing the ciphered unique identifier in the storage unit 150. When establishing the connection between the user device 100 and the server 200, the control unit 170 controls a connection setup with the unique identifier acquired in the previous connection with the server 200 and a conversion of the unique identifier at every hash round for security maintenance in the connected state. For example, the control unit 170 controls to a hash value updated based on the unique identifier according to a random Round_Count of the server during the connection setup with the server 200.

The power supply 180 supplies the power from the internal or external power source to the components of the user device 100.

It should be noted that the embodiments of the present invention may be implemented in hardware, firmware, or a combination thereof, and may be recorded in a computer readable storage medium. For a hardware implementation, the embodiments of the present invention may be implemented within one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, electronic devices, other electronic units designed to perform the functions described herein, or a combination thereof. In some cases, the embodiments of the present invention may be implemented in the control unit 170.

The storage medium may be a computer-readable storage medium storing the programs of displaying a CAPTCHA image received from the server during the initial connection procedure between the user device and the server, transferring a hash value computed using the security key input by the user, ciphering, when a connection response is received from the server, the security key, storing the ciphered key as unique identifier for the server, and transmitting, when requesting for reestablishment of the connection with the server using the stored unique identifier, the hash value updated based on the unique identifier according to the random round count of the server.

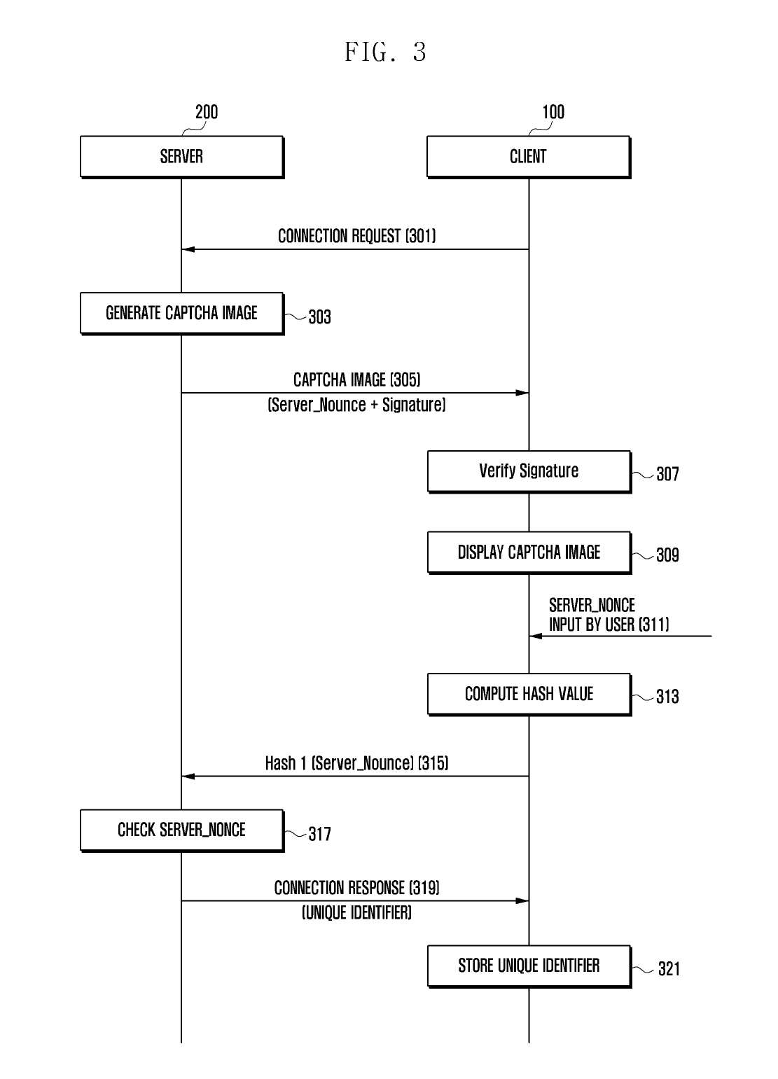

FIG. 3 is a signaling diagram illustrating the procedure of issuing unique identifier for communication between a user device and a server according to an embodiment of the present invention.

Referring to FIG. 3, the user device 100 sends the server 200 a connection request at step 301. For example, the user is capable of manipulating the user device 100 to establish a connection with the server 200. In response to the user input, the user device 100 attempts connecting to the server 200. Here, it is assumed that the user device 100 is attempting an initial connection to the server 200, so the user device 100 has no unique identifier issued by the server 200 yet.

Upon receipt of the connection request, the server 200 generates a CAPTCHA image with the first security key (Server_Nonce) as the unique identifier of the user at step 303. Next, the server 200 writes a signature with the private key (or Server Nonce) to the CAPTCHA image and sends the CAPTCHA image to the user device 100 at step 305. That is, the CAPTCHA image includes the first security key (Server Nonce) and signature of the server 200.

Upon receipt of the CAPTCHA image, the user device 100 checks the signature of the server 200 using the public key of the trusted server which has already retained at step 307. For example, upon receipt of the CAPTCHA image, the user device 100 compares the signature of the CAPTCHA image with the public key of the trusted server to verify the server 200 as the trusted server. In an embodiment of the present invention, step 307 of verifying the signature may be omitted.

If it is verified that the server 200 is the trusted server, the user device 100 displays the CAPTCHA image on the screen of the display unit 130 at step 309. In this state, the user is capable of checking the first security key (Server Nonce) of the CAPTCHA image and then enters certain information that includes a second security key at step 311. That is, the user is capable of entering the second security key (Server Nonce) in an input window of the UI or GUI presented on the screen.

If the second security key (Server Nonce) is input in the state that the CAPTCHA image is displayed, the user device computes the hash value using the second security key (Server Nonce) according to the user input at step 313. Next, the user device 100 sends the computed hash value to the server at step 315. For example, when the second security key (Server Nonce) is input by the user, the user device 100 computes the hash value through hashing the second security key (Server Nonce) with the hash function and sends the hash value through hashing the second security key (Server Nonce) to the server 200.

Upon receipt of the hash value in response to the CAPTCHA image, the server 200 determines whether the second security key (Server Nonce) with the received hash value is equal to the first security key at step 317. For example, the server 200 compares the first security key (Server Nonce) generated for use as the unique identifier of the user device 100 with the second security key (Server Nonce) of the received hash value to determines whether the security keys match each other. Here, the server 200 is capable of hashing the first security key (Server Nonce) to generate the hash value and comparing the generated hash value with the hash value received from the user device. At this time, the hash value of the server 200 can be the hash value computed when generating the corresponding first security key (Server Nonce) or when receiving the hash value transmitted by the user device 100.

If it is determined that the security key (Server Nonce) of the hash value received from the user device 100, the server 200 registers the corresponding security key (Server Nonce) as the unique identifier of the user device and accepts the connection request of the user device 200 at step 319. That is, the server 200 sends the user device 100 a connection response. At this time, the connection response may be transmitted with or without the unique identifier.

Upon receipt of the connection response, the user device 100 ciphers the unique identifier with the device information of the user device 100 as a ciphering key and stores the ciphered unique identifier in the storage unit 150 at step 321. In the case of transmitting the connection response with the unique identifier, the user device is capable of storing the unique identifier as ciphered. In alternate embodiment, the user device 100 is also capable of ciphering the security key (Server Nonce) according to the user input and then storing the ciphered unique identifier.

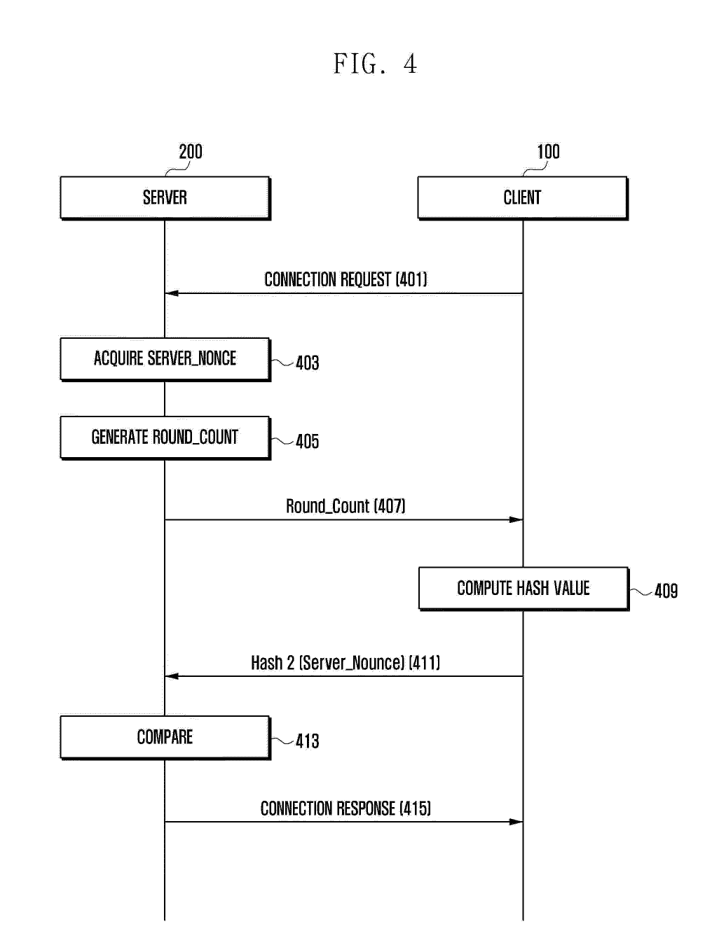

FIG. 4 is a signaling diagram illustrating the procedure of establishing a connection between a user device and a server after the issuance of a unique identifier according to an embodiment of the present invention.

Referring to FIG. 4, the user device 100 attempts a connection to the server 200 with the unique identifier issued by the server 200 as described with reference to FIG. 3 at step 401. That is, the user device 100 is capable of attempting connection to the server 200 with the hash value acquired by hashing the unique identifier issued by the server 200.

Upon receipt of the connection request, the server 200 acquires the security key (Server Nonce) of the user device at step 403. That is, the server 200 retrieves the unique identifier (i.e. Server Nonce) issued to the user device 100 from a database (DB). The server 200 may compares the retrieved unique identifier with the security key acquired by the received hash value. If no unique identifier of the user device 100 is retrieved, or if the retrieved unique identifier (Server Nonce) mismatch the unique identifier acquired with the received hash value, the server 200 may ignore the connection request of the user device 100 and terminate the procedure.

If the unique identifier of the user device 100 is retrieved or a match is found, the server 200 generates Round_Count at step 405 and sends the Round_Count to the user device 100 at step 407. The Round_Count may indicate the number of hashing operations of the unique identifier. The server 200 is capable of generating the Round_Count randomly, hashing the unique identifier in association with the Round_Count, and managing the generated hash value.

Upon receipt of the Round_Count form the server 200, the user device 100 computes the hash value by hashing the unique identifier with the Round_Count at step 409 and sends the hash value to the server 200 at step 411. That is, the user device 100 hashes the unique identifier (Server Nonce) stored as ciphered as many times as specified in the received Round_Count to generate a new hash value to be transmitted to the server 200.

Upon receipt of the hash value from the user device 100, the server 200 compares the computed hash value with the received hash value at step 413. If the hash values match, this means that the user device 100 is a trusted user device and thus the server 200 sends a connection response to the user device 100 at step 415.

As described above, according to an embodiment of the present invention, the user device is capable of attempting connection to the server 200 using the previously issued and stored unique identifier. At this time, the server 200 sends the user device 100 the random Round_Count in order for the user device 100 to attempt the connection with the previously issued unique identifier, and the user device 100 sends the server 200 a hash value acquired through hashing with the Round_Count. That is, according to an embodiment of the present invention, the user device 100 and the server 200 changes the hash round at every connection attempt to modify the transmission data so as to ward off the replay attack.

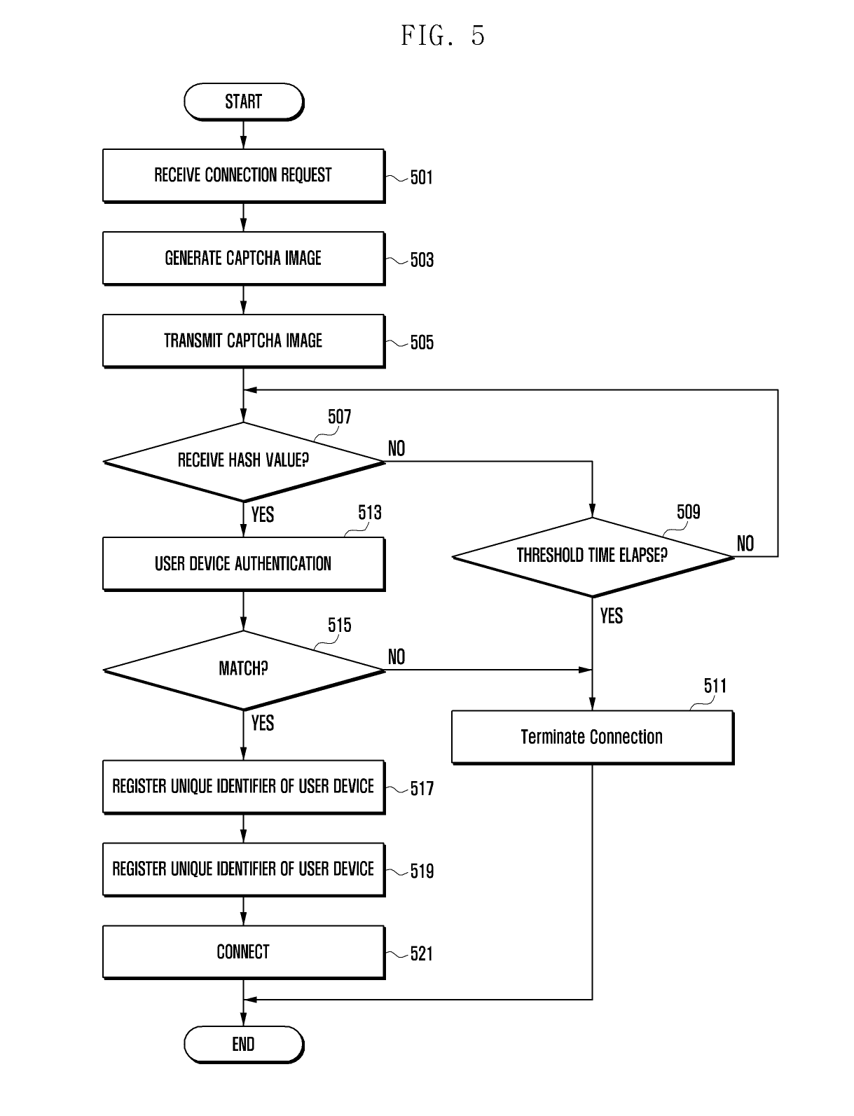

FIG. 5 is a flowchart illustrating the procedure for the server to issue a unique identifier to the user device according to an embodiment of the present invention.

Referring to FIG. 5, the server 200 receives a connection request from the user device attempting an initial connection to the server at step 501. When the connection request is received, the server 200 may determine whether the connection request is an initial connection request or reconnection request triggered by an event (e.g. content download, log-in, etc.). For example, the server 200 is capable of determining whether the connection request is transmitted with a previously issued unique identifier or not. If it is not the unique identifier-based connection request, this indicates that the user device 100 is attempting initial connection.

Upon receipt of the connection request from the user device, the server 200 generates a CAPTCHA image with the first security key (Server Nonce) to be used as the unique identifier of the user device 100 at step 503 and sends the CAPTCHA image to the user device 100 at step 505. At this time, the server 200 is capable of transmitting the CAPTCHA image with the signature of the private key (or Server Nonce) of the server 200.

The server 200 determines whether a hash value corresponding to the capture image is received at step 507. Here, the user device 100 displays the CAPTCHA image received form the server 200 and, if the user enters the second security key (Server Nonce) included in the CAPTCHA image for transmission, transmits the hash value computed with the entered second security key (Server Nonce) to the server 200. That is, the server 200 determines whether the hash value computed based on the second security key (Server Nonce) is received form the device 100.

If no hash value is received form the user device at step 507, the server 200 determines whether a predetermined threshold time duration has elapsed at step 509. The threshold time duration is the time waiting for a reply from the user device 100 in response to the CAPTCHA image. Until the threshold time duration elapses, the server returns the procedure to step 509. Otherwise, if the threshold time duration elapses at step 509, the server 200 ignores the connection request from the user device 100 and terminates the connection at step 511.

If a hash value is received from the user device 100 at step 507, the server 200 performs authentication of the user device 100 at step 513. For example, when the hash value corresponding to the CAPTCHA image is received from the user device 100, the server compares the compares the second security key (Server Nonce) of received hash value with the original first security key to authenticate the user device 100. At this time, the server 200 may compare the first security key (Server Nonce) generated for use as the unique identifier of the user device 100 with the second security key of the received hash value to verify the received second security key (Server Nonce).

The server 200 compares the first security key (Server Nonce) generated by the server 200 and the second security key (Server Nonce) of the hash value received from the user device 200 to determine whether the security keys match each other at step 515. At this time, the server 200 is capable of computing the hash value by hashing the generated first security key (Server Nonce) and comparing the generated hash value with the hash value received from the user device 100. The hash value may be computed at the time when the server 200 generates the first security key (Server Nonce) or at the time when the hash value transmitted by the user device 200 is received. The server 200 is also capable of extracting the second security key (Server Nonce) from the received hash value and comparing the extracted hash value with the server-generate first security key (Server Nonce).

If the server-generated first security key (Server Nonce) and the second security key (Server Nonce) transmitted by the user device 100 mismatch at step 515, the server 200 ignores the connection request of the user device 100 and terminates the connection at step 511.

If the server-generated first security key (Server Nonce) and the second security key (Server Nonce) transmitted by the user device 100 match at step 515, the server 200 registers the security key (Server Nonce) as the unique identifier of the user device 100 at step 517. That is, the server 200 maps the unique identifier to the user device 100 in the database.

Once the user device 100 is registered with the database along with the unique identifier normally, the server 200 sends the user device 100 a connection response in reply to the connection request transmitted by the user device 100 at step 519, and then establishes the connection with the user device 100 at step 521. For example, the server 200 accepts the connection request of the user device 100 and sends the connection response with the unique identifier and/or information notifying of the registration of the unique identifier.

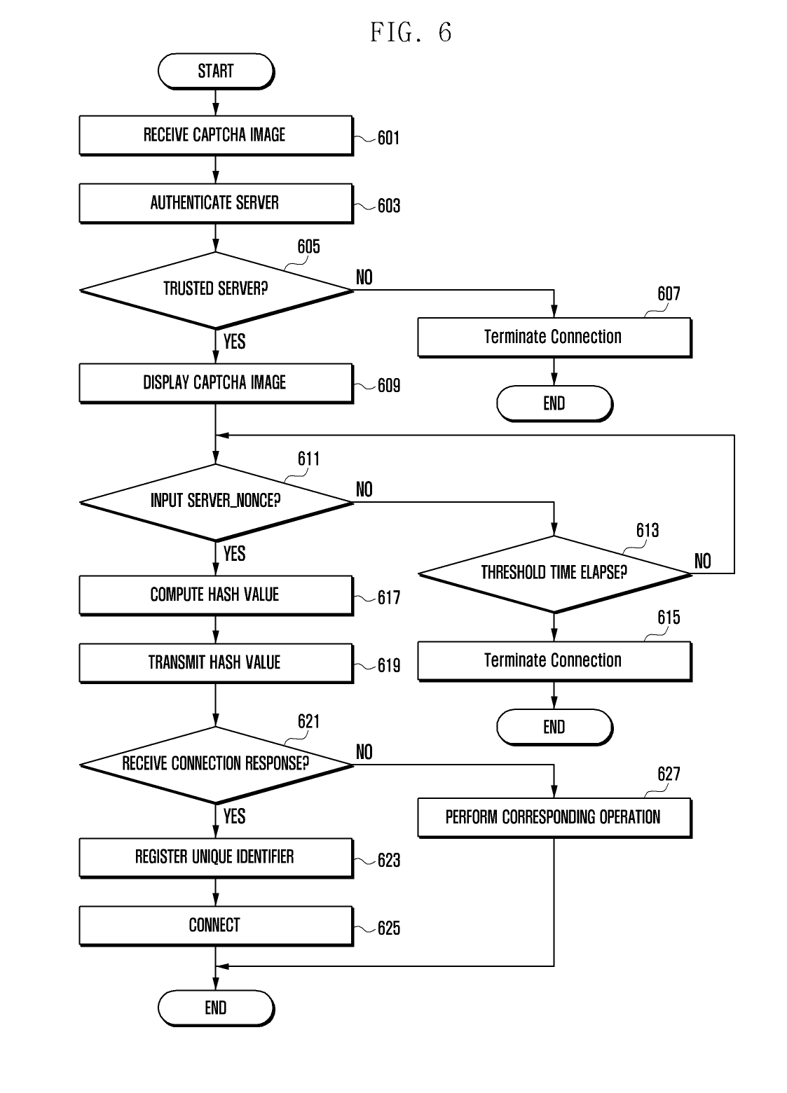

FIG. 6 is a flowchart illustrating the procedure for the user device to acquire unique identifier for use in connection with the server according to an embodiment of the present invention.

Referring to FIG. 6, the user device 100 receives a CAPTCHA image from the server 200 at step 610 and authenticates the server 200 at step 603. For example, the user device 100 sends a connection request to the server 200 according to the user's request and receives the CAPTCHA image transmitted by the server 200 in response to the connection request. The user device 100 checks the signature of the server 200 using the public key of the trusted server which that user device 100 has retained to authenticate the server 200 transmitted the CAPTCHA image and determines whether the server 200 is the trusted server at step 605.

If it is determined that the server 200 transmitted the CAPTCHA image is an untrusted server at step 605, the user device 100 ignores the received CAPTCHA image and terminates the connection at step 607.

Otherwise, if it is determined that the server 200 transmitted the CAPTCHA image is the trusted server at step 605, the user device 100 displays the CAPTCHA image on the screen at step 609 and monitors to detect the input of the second security key (Server Nonce) by the user at step 611. That is, the user device 100 waits for the user's input of a second security key (Server nonce) in the state of displaying the received CAPTCHA image. Here, the CAPTCHA image is displayed with a first security key (Server Nonce) generated by the server 200.

If no security key (Server Nonce) input is detected at step 611, the user device determines whether a predetermined threshold time duration has elapsed at step 613. The threshold time duration is the time waiting for a user's input of the second security key (Server Nonce) in the state of displaying the CAPTCHA image received from the server 200. The user device 100 returns the procedure to step 611 until the threshold time duration elapses. If the threshold time duration has elapsed at step 613, the user device 100 terminates the connection with the server 200 at step 615.

If a second security key input of the user is detected at step 611, the user device 100 computes the hash value using the second security key (Server Nonce) input by the user at step 617. For example, the user is capable of checking the first security key (Server Nonce) of the CAPTCHA image displayed on the screen and entering the second security key. That is, the user is capable of entering the checked second security key (Server Nonce) in the input window of the UI or GUI presented on the screen. Upon receipt of the user input, the user device 100 generates a hash value by hashing the second security key (Server Nonce) input by the user with the hash function negotiated with the server 200.

The user device 100 sends the server 200 the hash value generated based on the second security key (Server Nonce) input by the user at step 619, and then determines whether a connection response is received from the server 200 at step 621.

If the connection response is received from the server 200 at step 621, the user device registers the security key (Server Nonce) used previously as the unique identifier for the server at step 623 and establishes the connection to the server 200 at step 625. At this time, if the connection response is received from the server 200, the user device 100 is capable of ciphering the unique identifier with the device information of the user device 100 as the ciphering key and storing the ciphered unique identifier in the storage unit 150. In the case that the connection response is received along with the unique identifier from the server 200, the user device 100 is capable of storing the received unique identifier as ciphered. In the case that the connection response is received without the unique identifier, the user device 100 is capable of ciphering the second security key (Server Nonce) input by the user and storing the ciphered result as the unique identifier.

If no connection response is received from the server at step 621, the user device 100 performs a corresponding operation at step 627. For example, the user device 100 is capable of waiting for receiving the connection response during for predetermined time duration. If the predetermined time duration has elapsed without receipt of the connection response, the user device 100 is capable of displaying an error message and requesting for retransmission of the CAPTCHA image or terminates the connection attempt to the server 200. If an error message, instead of the connection response, is received from the server 200, the user device displays an error message on the screen and returns the procedure for receiving the first security key (Server Nonce) according to the user request.

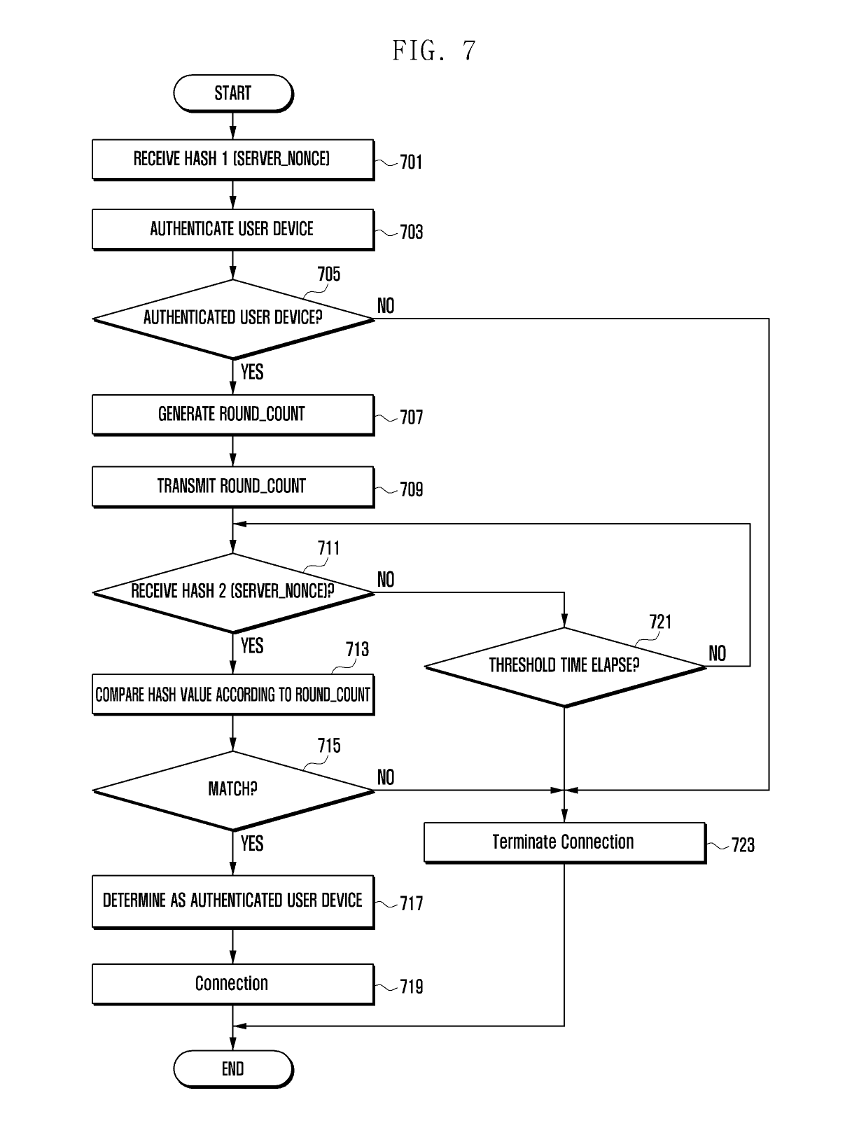

FIG. 7 is a flowchart illustrating the procedure for the server to authenticate the user device according to an embodiment of the present invention.

Referring to FIG. 7, if a hash value (hereinafter, referred to as first hash value) is received form the user device 100 at step 701, the server 200 performs authentication to the user device 100 at step 703. For example, the user device 100 is capable of attempting connection to the server 200 using the unique identifier (or Server Nonce) issued by the server 200 previously. Upon receipt of the connection request from the user device 100, the server 200 is capable of retrieving the unique identifier (or Server Nonce) mapped to the user device from the database. The server 200 compares the retrieved unique identifier and the unique identifier (or Server Nonce) transmitted by the user device 100 to determines whether the user device is a normally registered user device at step 705. That is, if the unique identifiers match, the server 200 regards the user device as authenticated user device and, otherwise, as non-authenticated user device.

If it is determined that the user device 100 is a non-authenticated user device at step 705, the server 200 ignores the connection request of the user device 100 and terminates the connection at step 723.

If it is determined that the user device 100 is the authenticated user device at step 705, the server 200 generates a round count for hashing the unique identifier at step 707 and sends the round count to the user device 100 at step 709. Here, the server 200 is capable of generating the round count randomly, hashing the unique identifier retrieved from the data based with the round count, and managing the hash value generates as a consequence (reference hash value).

After transmitting the round count, the server 200 monitors to receive a hash value (hereinafter, referred to as second hash. The first and second hash values may differ from each other at step 711. That is, after transmitting the round count, the server 200 waits for receiving the second hash value acquired by hashing the unique identifier with the round count from the user device 100.

If the second hash value is not received from the user device 100 at step 711, the server 200 determines whether a predetermined threshold time duration has elapsed at step 721. The threshold time duration represents the waiting time for the response from the user device 100 after transmitting the round counter. If the threshold time duration has not elapsed at step 721, the server 200 returns the procedure to step 711. Otherwise, if the threshold time duration has elapsed at step 721, the server 200 terminates the connection of the user device 100 at step 723. In this way, although the first has value is faked for replay attack, if the second hash value is not received with the changed hash round, the server regards the transmission of the user device 100 as replay attack so as to terminate the connection with the user device 100.

If the second hash value is received from the user device at step 711, the server 200 compares the reference hash value computed with the round count with the received second hash value at step 713 and determined whether the reference hash value and the second hash value match each other at step 715. Here, the reference hash value can be generated at the time where the round count is transmitted or when the second hash value is received from the user device 100.

If the reference hash value and the second hash value mismatch at step 715, the server terminates the connection with the user device 100 at step 723. Otherwise, if the reference hash value and the second hash value match at step 715, the server 200 regards the user device 100 as the valid user device at step 717 and establishes the connection with the user device 100. According to an embodiment of the present invention, the user device 100 and the server changes the hash round randomly at every connection instance to modify the data so as to ward off the replay attack.

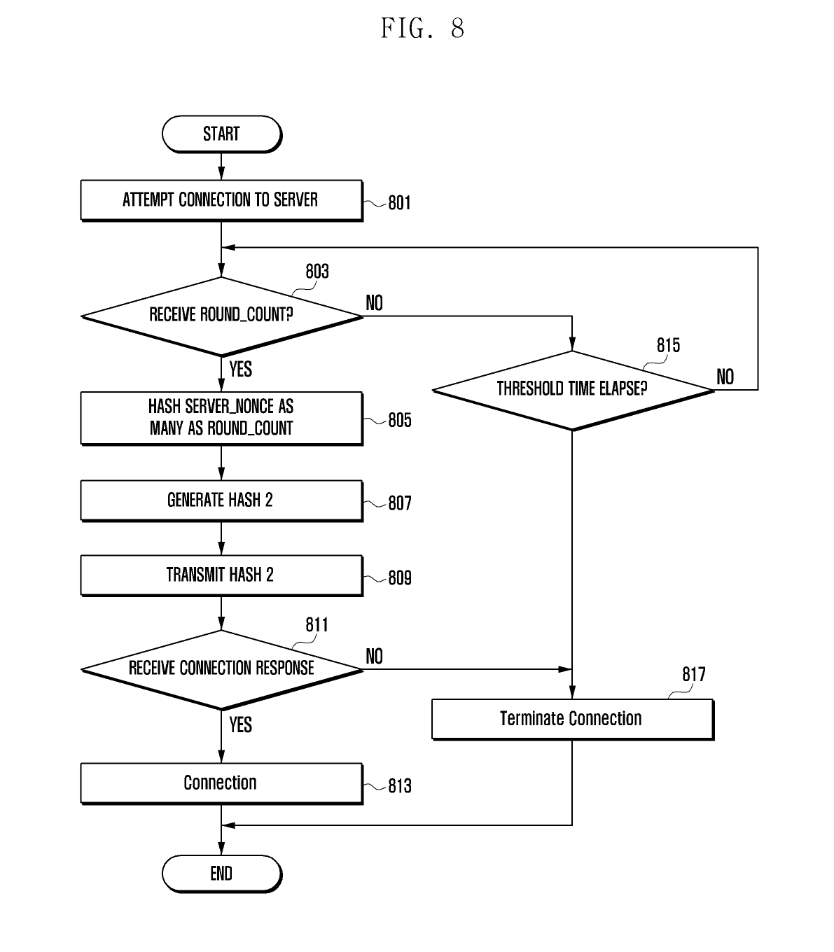

FIG. 8 is a flowchart illustrating the procedure for the user device to establish a connection to the server using a unique identifier according to an embodiment of the present invention.

Referring to FIG. 8, the user device 100 attempts a connection to the server according to the user's request, at step 801. At this time, the user device 100 computes a hash value (first hash value of the embodiment of FIG. 7) based on the unique identifier issued previously by the server 200 and stored in the user device 100 and sends the first hash value to the server 200.

The user device 100 monitors to receive the round count transmitted by the server 200 after transmitting the first hash value at step 803.

If no round count is received from the server 200 at step 803, the user device 100 determines whether predetermined time duration has elapsed at step 815. The threshold time duration represents the waiting time for the receipt of the round count from the server 200 after the transmission of the first hash value. If the threshold time duration has not elapsed at step 815, the user device 100 returns the procedure to step 803. Otherwise, if the threshold time duration has elapsed at step 815, the user device 100 terminates the connection attempt to the server 200 at step 817.

If the round count is received from the server 200 at step 803, the user device 100 performs hashing on the unique identifier as many times as specified in the round count at step 805 and generates a hash value (i.e. second hash value of the embodiment of FIG. 7) at step 807. Next, the user device 100 sends the server 200 the second hash value acquired by hashing the unique identifier according to the round count at step 809. That is, the user device 100 performs hashing on the unique identifier (Server Nonce) stored as ciphered according to the round count received from the server 200 to generate a new hash value (i.e. a value different from the first value) and sends the new hash value to the server 200.

After transmitting the second hash value, the user device 100 monitors to receive a connection response from the server 200 at step 811. If no connection response is received at step 811, the user device 100 terminates the connection attempt to the server 200 at step 817. Otherwise if the connection response is received from the server 200 at step 811, the user device 100 establishes the connection to the server 200 at step 813. As described above, according to an embodiment of the present invention, the user device 100 and the server 200 changes the hash round randomly at every connection instance to modify the transmission data so as to ward off the replay attack.

As described above, the unique identifier provision method and apparatus of the present invention is characterized in that the server converts the information to be used as the unique identifier of the user to an image and provides the same to the user device. The user device displays the image on the screen in order for the user to check the image and input a value directly and processes the user input value to generate a hash value to the server. The unique identifier provision method and apparatus of the present invention in characterized that the information necessary for authentication between the user device and the server is input by the user and transmitted to the server in the form of hash value such that the server is capable of distinguishing the user's connection request from the faked request generated by the illegal computer program such as virus.

As a result, the unique identifier provision method and apparatus is capable of warding off the server overload attack by malevolent code, negates collecting information on the user device and/or user when establishing a connection between the user device and the server, so as to protect against illegal data use, and prevents a certain malevolent program such as packet monitor program from eavesdropping the information on the key used for authentication information (i.e. unique identifier transmitted as included in an image).

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the invention has been shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A unique identifier provision method of a user device, the method comprising:
displaying a CAPTCHA image received from a server in response to a connection request to the server;
receiving a security key input, the security key being included in the CAPTCHA image;
computing a hash value using the security key input;
transmitting the hash value to the server; and
storing, when a connection response is received from the server in response to the hash value, the security key based on the hash value as a unique identifier used for connection with the server.

2. The method of claim 1, wherein the storing step comprises:
ciphering the security key with information of the user device as a ciphering key; and
storing the ciphered unique identifier.

3. The method of claim 1, wherein storing step comprises:
ciphering, when the connection response is received, the unique identifier included in the connection response with information of the user device as a ciphering key; and
storing the ciphered unique identifier.

4. The method of claim 1, further comprising:
transmitting to the server a first hash value generated using the stored unique identifier in connection attempt to the server;
generating, when a Round_Count that indicates a number of hashing operations for generating a second hash value is received from the server in response to the first hash value, the second hash value by hashing the unique identifier as many times as specified in the Round_Count;
transmitting the second hash value to the server; and
establishing, when a connection response is received form the server in response to the second hash value, a connection with the server.

5. The method of claim 4, wherein the hash value is changed at each of the connection attempt according to a random Round_Count provided by the server.

6. The method of claim 4, further comprising terminating, when the Round_Count is not received or when the connection response is not received from the server, the connection with the server.

7. The method of claim 1, wherein the displaying step comprises:
determining whether the server is a trusted server; and
displaying the CAPTCHA image when the server is determined to be the trusted server.

8. The method of claim 1, wherein the CAPTCHA image transmitted from the server includes a private key to serve as the unique identifier of the user device.

9. A unique identifier provision method of a server, the method comprising:
receiving a connection request from a user device;
transmitting to the user device a CAPTCHA image including a private key serving as a unique identifier of the user device;
determining, when a hash value generated with the private key included in the CAPTCHA image is received from the user device, whether a security key of the received hash value matches the private key;
registering, when there is a match, the security key as the unique identifier of the user device; and
transmitting a connection response to the user device for establishing a connection.

10. The method of claim 9, wherein transmitting the connection response comprises generating the connection response with or without the unique identifier of the user device.

11. The method of claim 9, further comprising:
receiving the connection response with the registered unique identifier from the user device;
transmitting a random Round_Count that indicates a number of hashing operations for generating the security key to the user device in response to the connection request; and
receiving a hash value hashed according to the random Round_Count from the user device.

12. The method of claim 11, wherein transmitting the random Round_Count comprises:
retrieving the unique identifier issued to the user device from a database of the server;
generating, when the unique identifier is retrieved, the random Round_Count; and
transmitting the random Round_Count to the user device;

13. The method of claim 12, wherein the retrieving step comprises comparing the unique identifier registered for the user device with the hash value received from the user device;

14. The method of claim 13, wherein the comparing step comprises:
comparing a hash value computed by the server with the received hash value corresponding to the random Round_Count received form the user device; and
transmitting, when the computed hash value and the received hash value matches, the connection response to the user device.

15. The method of claim 14, wherein the hash value is generated by hashing the retrieved unique identifier as many times as specified the random Round_Count.

16. The method of claim 15, further comprising terminating the connection with the user device when the unique identifier corresponding to the user device is not retrieved or when the retrieved unique identifier does not match the received hash value.

17. The method of claim 13, further comprising transmitting the Round_Count generated randomly for each connection with the user device.

18. The method of claim 11, wherein transmitting the CAPTCHA image to the user device comprises writing a private key of the server as a signature on the CAPTCHA image.

19. A user device comprising:
a display which displays a CAPTCHA image including a security key from a server;
a user interface which receives the security key included in the CAPTCHA image; and
a controller controlling the display unit for displaying the CAPTCHA image received from the server in response to an initial connection attempt, transmitting a hash value computed using the security key, ciphering the security key with information of the user device, storing the ciphered security key in a storage as a unique identifier of the server, and transmitting, when establishing a connection with the server, a different hash value generated using the stored unique identifier and according to a random Round_Count received from the server.

20. A unique identifier provision system, the system comprising:
a server which transmits a CAPTCHA image having a security key serving as unique identifier of a user and registers, when a hash value computed using the security key from the user device, the security key based on the hash value as the unique identifier of the user device; and
the user device which displays the CAPTCHA image received from the server, transmits, when the security key included in the CAPTCHA image is inputted, the hash value computed using the security key from the server, and registers, when a connection response is received from the server in response to the hash value, the security key based on the hash value as the unique identifier for connection with the server.
